(19) United States
(12) Patent Application Publication
(10) Pub. No.: US 2025/0181522 A1
(43) Pub. Date: Jun. 5, 2025

(54) CACHE SYSTEM AND METHOD

(71) Applicant: Infineon Technologies AG, Neubiberg (DE)

(72) Inventor: Alistair Jackson, Wotton under edge (GB)

(21) Appl. No.: 18/961,538

(22) Filed: Nov. 27, 2024

(30) Foreign Application Priority Data
Nov. 30, 2023 (DE) 10 2023 212 040.2

(51) Int. Cl. G06F 12/14

(52) U.S. Cl. CPC G06F 12/1466; G06F 2212/602

(57) ABSTRACT

A cache system is provided for system with a CPU and memory. The CPU has a stack pointer register for storing a stack pointer. The stack pointer represents an address in main memory at the top of the stack. The cache system has a cache RAM structured into cache lines and cache controller circuitry. The cache controller circuitry is operable to: receive the stack pointer, store a first cache line containing the contents of a first address range of bytes of the main memory, the first address range including the stack pointer; and lock the first cache line to protect the first cache line from cache eviction.

### REFERENCE TO RELATED APPLICATIONS

This application claims priority to German Patent Application 102023212040.2, filed on Nov. 30, 2023, the contents of which are hereby incorporated by reference in their entirety.

### TECHNICAL FIELD

The present disclosure relates to the use of a cache and a processor system using a cache.

### BACKGROUND

Modern processors use processor cores which access data from memory using a cache. The purpose of the cache is to maintain CPU performance by accelerating access to commonly used data. The cache is a fast memory. Certain data from main memory is stored in the cache so that it can be accessed faster than data stored in the main memory. The cache size is limited and organized as a set of lines, each of fixed size.

The cache may use a cache controller, also referred to simply as a “controller” that reads data from main memory into the cache when needed. Usually, a line of data needs to be removed from the cache to make way for a new line of data.

CPU performance depends heavily on cache operation, as accessing data causes a performance loss when it needs to be read from slow main memory.

### SUMMARY

In an example, there is provided a cache system for a processor having a stack pointer register for storing a stack pointer, the stack pointer being a main memory address of the top of a stack, comprising:
a. a cache memory structured into cache lines; and
b. cache controller circuitry operable to:
c. receive the stack pointer (SP),
d. store a first cache line containing the contents of a first address range of bytes of the main memory, the first address range including the stack pointer address; and
e. lock the first cache line to protect the first cache line from cache eviction.

Note that the stack pointer may point to an address in the address space of the device, e.g., the address is an address in main memory. By storing a cache line of data including the data in the address pointed to by the stack pointer, the contents of the stack can be quickly accessed in the cache without needing to load the data from main memory. By locking this line of data, this line of data stays in the cache even if otherwise it would have been replaced.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 illustrates a system including a CPU, Cache and memory;

FIG. 2 illustrates various parts of a memory address;

FIG. 3 illustrates a tag memory;

FIG. 4 illustrates a cache line of data; and

FIG. 5 illustrates a hardware circuit in a cache controller.

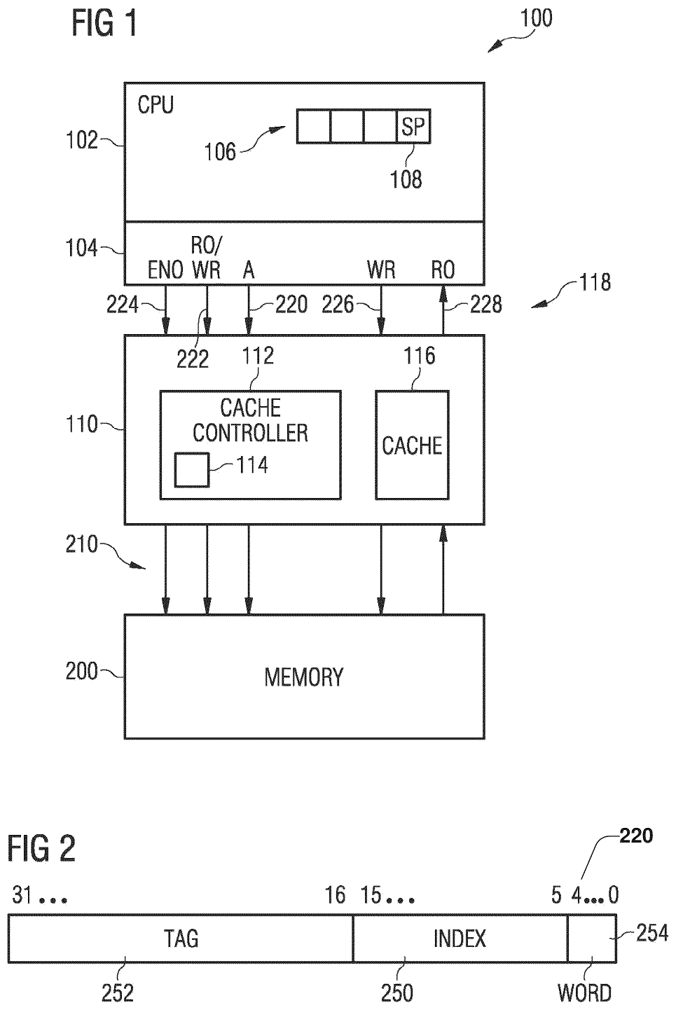

### DETAILED DESCRIPTION

### Data Cache

In an example a computer system 100 has a CPU 102. The CPU has registers 106 which may be accessed very quickly but these are of limited size. Thus, a main memory 200 is also provided. The CPU has a load/store interface 104 connected through a number of interconnects 118 to a cache 110. The cache 110 contains a cache controller 112, a tag RAM 114 and a cache RAM 116. The cache 110 is connected through bus 210 to main memory 200.

The cache RAM 116 contains a number of cache lines 400 of data, each cache line of data containing a number of data words. For example, each data word may include 32 bits and each cache line of data may include 32 such words. In this case, 5 bits are needed to identify each individual word within the cache line (25=32); these five bits may be referred to as the word address.

The interconnects 118 include an address line 220, a read/write line 222 and an enable line 224, all connected to be driven by the load/store interface. The interconnects also include a data write line 226 and a data read line 228. Note that although the address line 220, write line 226 and read line 228 are shown schematically as single lines these may in fact be a plurality of lines, for example 32 lines in parallel to carry a 32 bit data item or address. Generally, for example, there can be M address lines where M is any positive integer, and typically M is an integer power of two (e.g., M=2\hat{ }4=16; M=2\hat{ }5=32; M=2\hat{ }6=64; or M=2\hat{ }7=128).

In order for the CPU 102 to access the contents of memory 200, which may contain either program code or data, it outputs an address, for example a 32 bit address, on address line 220. The CPU also controls Read/Write line 222 to indicate if it is to read the contents of that address or to write. The CPU also controls Enable line 224 to enable the cache.

At least some, typically most, possible memory locations in main memory 200 are cacheable memory locations, that is to say the data stored in the main memory 200 at that memory location may be stored in cache 110 for faster access. When the CPU 102 accesses a cacheable memory location for a write or read, the request may be output by the CPU load/store interface 104 and received by the cache controller 112. The cache controller 112 checks the memory address to determine if the addressed location is already present in the cache (cache lookup).

In an example, the memory address 220 in memory 200 is divided into a tag part 252, an index part 250, and a byte address part 254, see FIG. 2. For example, the 16 most significant bits of the memory address may represent the tag part 252, the next 11 bits the index part 250 and the remaining 5 bits the write address part 254, the latter which represents the location within a cache line. Note that these 5 bits correspond to the location within the cache line, e.g., the word address. The cache controller 112 calculates a tag RAM address from the index part 250 of the memory address 220 and compares the contents of that part of the tag RAM with the tag part 252 of the memory address 220. If and only if the corresponding tag RAM address contains the tag part 252 then the cache already contains the contents of memory address.

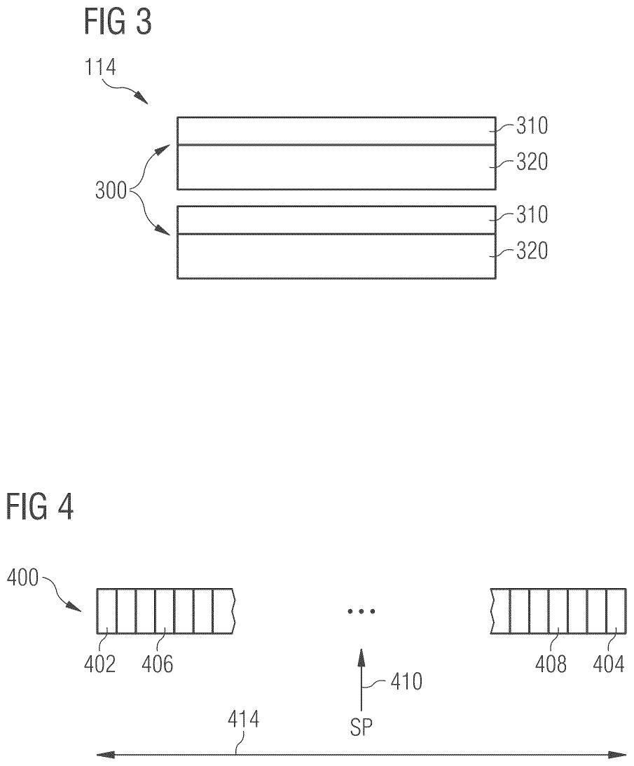

The cache RAM 116 may be for example a two-way cache, containing two cache lines. The tag RAM 114 reflects this in that each tag RAM addressable word 300 specified by the index contains two tags 310, 320 (FIG. 3). Moreover, each of those two tags corresponds to a separate cache line 400 of data. Those skilled in the art will realize that as an alternative three-way, four-way cache architecture may be used with each index corresponding to three, four or more cache lines 400 in cache RAM 116 and in such a case three, four or more respective tags may be stored in each tag RAM addressable word.

If the tag matches the tag RAM contents at either way, this indicates the requested data is already in the cache (cache hit) and the read or write can take place immediately using the cached data.

Alternatively, if the tag does not match, a cache miss has occurred. In order to access the requested data the data is downloaded from memory 200. To do this, the cache controller first loads a line of data containing the requested location from main memory into the cache (refill operation); this line of data is referred to as a cache line 400, and includes a line of data including the data at the requested memory address. Note that the line of data is the data stored in an address range of data in main memory 200. The address range has a lower and an upper value. For example, a cache line may contain 32 words of data, each of 32 bits, and the upper value of the address range is 31 greater than the lower value.

On a refill the cache controller will allocate one of the available ways at that index in which to store the data newly read from main memory. Usually the cache is fully occupied so the cache controller evicts one line that is already stored in the cache from the cache to make space (cache line eviction). The evicted cache data is written back to main memory if it had been modified (write back), alternatively the cache line is simply invalidated, before being overwritten.

Cache line eviction may be controlled according to a least-recently-used (LRU) algorithm. The cache controller maintains a flag bit for every index that indicates which way (out of 2 available) was the least recently accessed and therefore which should be evicted by preference. The intention is to retain the most recently accessed data in the cache for performance reasons.

### Program Stack

The program stack is a data structure in memory. It is maintained by the microprocessor system and operating software to temporarily store data (and program code addresses) and it is very frequently accessed. One of the registers 106 is a stack pointer register 108 used to store a stack pointer 410 which is an address in the main memory at the top of the stack. Data is pushed to the stack to store it, and popped from the stack to restore it, while the stack accordingly grows and shrinks in memory. In both cases, the data is stored or accessed at the location of the stack pointer, and the stack pointer then incremented or decremented accordingly.

By keeping the most-recently-accessed part of the stack (stack top) in the fast local cache, the system maintains high performance by avoiding the degradation that would occur if the stack top was evicted from the cache.

The stack top is very frequently accessed and because of this it is often retained in the data cache by normal operation of the LRU mechanism. However, there is no guarantee that the LRU mechanism will retain the cache line with the top of the stack in the cache.

### Locking

In examples, a part of the data cache is identified as containing the stack top, by using the stack pointer 410 stored in stack pointer register 108. This cache line is then locked so that it cannot be evicted even if it normally would be by the LRU. As the stack top moves up and down through the memory address space, the stack pointer automatically indicates the address of data to be locked in the cache. Thus, the cache line, including the data at the stack pointer, e.g., at the address in main memory pointed to by the stack pointer, is kept in the cache memory even if otherwise the LRU algorithm would remove the cache line.

When a cache line is locked it is protected from eviction by overriding the LRU flag at that index, and the alternate way is chosen for eviction even if it was more recently used.

The benefits of automatically locking the cache line containing stack top as described here may be directly measurable in reduced execution times for some test programs.

The cache line locking function may be performed by the cache controller. It is supplied with the tag and index parts of the locking memory address and a flag bit to indicate the locking address validity. The cache controller compares the locking tag on every cache lookup to the locking index. When the locking tag matches, the cache controller sets a flag bit to override the LRU should the cache lookup result in a miss, subsequent refill operation and cache line eviction. Thus the locked cache line is protected from eviction.

FIG. 5 illustrates a cache controller design that may be implemented in hardware that implements the two way cache and locking.

Address line 220 is connected to index address lines 512 carrying the index part 250 and to tag address lines 510 carrying the tag part 252.

The index address lines 512 are connected to tag RAM 114 and to LRU 500. The tag RAM 114 has first write output 506 and second write output 508 which are connected to first tag comparator 502 and second tag comparator 504 respectively. The tag address lines 510 are also connected to the first and second tag comparators 502, 504.

A locking subsystem 526 accepts a locking address on locking address lines 528. The locking subsystem has a locking tag comparator 532 connected to tag address lines 510 and a locking index comparator 530 connected to index address lines 512. The locking index comparator 530 and locking tag comparator 532 are also connected to the respective parts of the locking address lines 528. The outputs of the locking comparators 530, 532 are connected through logic circuit 542 (e.g., AND gate) to lock output 536.

In use, when an address is input, the LRU 500 outputs a LRU signal 520 indicating which of the first and second cache lines corresponding to the address index was most recently used. The tag RAM 114 outputs as tag data on first write output 506 the tag stored in the first way 310 at the index location and outputs at the second write output 508 the tag stored in the second way 320 at the index location in the tag RAM 114. These are then compared in the first and second tag comparators 502, 504 to output a first tag output 522 on first tag comparator 502 which indicates a hit for the first way and a second tag output 524 on second tag comparator 504 which indicates a hit for the second way.

Similarly, the locking index comparator 530 and locking tag comparator 532, 532 compare the input on locking address lines 528 with the tag and index parts of the address input on address line 220 and outputs a locked signal at lock output 536 in the event that the address is locked. The locking address lines 528 may deliver the address that is locked, and may for example by a stack pointer.

The cache controller can then simply access the data in the cache if a hit is indicated at first tag output 522 or second tag output 524.

If there is no hit, data from main memory is loaded into the cache. If the locked output does not indicate a lock, the way of data in cache RAM 116 indicated by the LRU output is cleared and replaced by the data loaded from main memory 200. If in contrast the locked output indicates that one of the ways is locked, then the other way is cleared and replaced by the data loaded from main memory.

In some cases, there are multiple address lines 220, and the index address lines 512 and tag address lines 510 “split” or branch from the multiple address lines 220. For example, in some cases, there are M address lines 220 (e.g., M=32, see FIG. 2), O index address lines 512 (e.g., O=12, see FIG. 2), and N tag address lines 510 (e.g., N=16, see FIG. 2). Further, there can be K locking address lines 528, wherein K is an integer that is equal to or greater than O+N. O locking index lines 538 and N locking tag lines 540 can “split” from the locking address lines 528. Thus, the first index comparator 530 has a first input coupled to the O index address lines 512 and a second input coupled to the O locking index lines 538. The second index comparator 532 has a first input coupled to the N tag address lines 510 and a second input coupled to the N locking tag lines 540. The locking index comparator 530 and the locking tag comparator 532 have respective outputs that are coupled to respective inputs of a logic circuit 542, which is illustrated as a logical AND gate in FIG. 5 though other logic circuits could also be used.

An alternative version of the design allows for multiple lines to be locked. The cache controller is supplied with multiple locking memory addresses, and the comparison described above is repeated for each. Should any locking tag match the requested memory address on a cache lookup at the same index, another flag bit is set to indicate the LRU should be overridden in the event of a cache line miss. If all of the available ways at that index are so locked, the cache controller resorts to using the LRU again to select one way for eviction.

The system may track one or more previous values of the stack pointer. These are used again to selectively and dynamically lock data in the fast local cache so that most-recently accessed stack top data is not evicted.

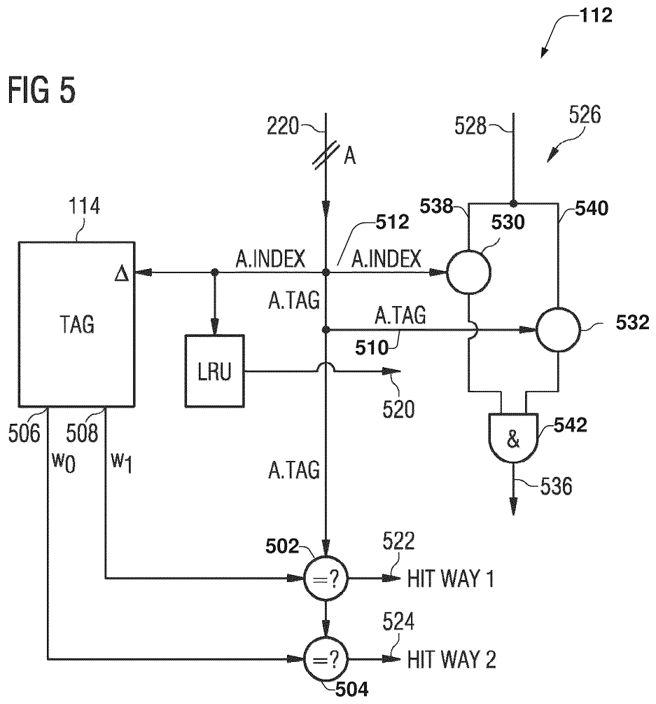

For example, lower and upper limits may be predetermined set in the address range of the cache line of data. For example, in the event that a first cache line 400 having a first address range contains 32 words represented by the five bit word address as in the example above the predetermined lower limit may be three higher than the lower value of the address range and the predetermined higher limit may be three lower than the upper value of the address range. See FIG. 4, which illustrates cache line 400, lower value 402, upper value 404, lower threshold 406 and upper threshold 408. The first address range 414 in main memory corresponding to lower value 402 to upper value 404 is the address range represented in this cache line 400.

In the case that the stack pointer 410 is between the lower and the upper thresholds, then the stack pointer is increased and decreased as data is stored in the stack and taken from the stack, but there is no need to access main memory 200 as the data in this address range is stored in the cache line 400 in cache RAM 116.

If however the stack pointer 410 passes upper threshold 408, then there is a risk that the stack pointer will continue to rise and pass the upper value 404. This would then cause a stack miss and further delay. To mitigate this risk, the cache controller 112 can be arranged to read a further cache line of data corresponding to a further address range immediately above the first address range 414. In some examples, also this additional line of data may be locked. In this way, the risk of a cache miss is reduced.

Similarly, if the stack pointer 410 falls below lower threshold 406 then the cache controller 112 may load a further cache line of data, in this case corresponding to a further address range immediately below the first address range. In some examples, this line of data may be locked. In this way the risk of a cache miss is reduced.

Although specific examples have been illustrated and described herein, it will be appreciated by those of ordinary skill in the art that a variety of alternate and/or equivalent implementations may be substituted for the specific examples shown and described without departing from the scope of the present invention. This application is intended to cover any adaptations or variations of the specific examples discussed herein. Therefore, it is intended that this invention be limited only by the claims and the equivalents thereof.

In a first example, there is provided a cache system for a processor having a stack pointer register for storing a stack pointer, the stack pointer being the address in main memory of the top of a stack, comprising: a cache memory structured into cache lines; and cache controller circuitry operable to: receive the stack pointer (SP), store a first cache line containing the contents of a first address range of bytes of the main memory, the first address range including the stack pointer; and lock the first cache line to protect the first cache line from cache eviction.

The cache controller circuitry may be further operable, when the stack pointer register contains a new stack pointer having an address outside the first address range, to: store in the cache a further cache line containing the contents of a further address range including the new stack pointer; and lock the further cache line.

The cache system may lock the first cache line and the further cache line but unlock any previous cache line corresponding to a previous stack pointer address.

The cache controller circuitry may be further operable to: lock a plurality of addresses of respective cache lines that correspond to the stack pointer.

The cache controller circuitry may be further operable to: determine a low threshold address in the first address range; determine a high threshold address in the first address range; determine if the stack pointer exceeds the high threshold address and if so, pre-fetch a further cache line of data from the address range in main memory immediately above the first address range into the cache; or determine if the stack pointer is below the second threshold, and if so, pre-fetch a further cache line of data from the address range in main memory immediately below the low threshold address.

The cache controller circuitry may be further operable to: lock the address of the further one cache line including the pre-fetched data.

The low threshold address and/or high threshold address may be at a programmable position within the first cache line.

The cache controller circuitry may be operable to lock the address of the cache line in a dynamic manner.

The cache controller circuitry may be operable to: lock the address by overriding an output of a least recently used (LRU) logic to protect the cache line from eviction should a cache lookup result in a miss, a cache line eviction, and cache line refill.

The cache controller circuitry may comprises: a lock detection circuit operable to determine whether a request address received from a processor corresponds with the locked address.

The cache memory may be organized as a multi-way set associative memory.

In an example, there may be provided a microcontroller, comprising the cache system as set out above.

The microcontroller may further comprise: a processor; and a main memory, wherein the cache system is communicatively coupled between the processor and the main memory to manage data flow there between.

In an example there may also be provided a method for managing a cache memory structured into cache lines, comprising: receiving, by cache controller circuitry from a processor, a stack pointer which indicates the address in main memory of the top of a stack; and locking, by the cache controller circuitry, a cache line including the top of the stack to protect the cache line from cache eviction.

The method may further comprise: updating the stack pointer to an address not stored in the cache line in the cache memory, storing a further cache line corresponding to the updated address; and locking the further cache line.

The method may further comprise: locking a plurality of cache lines that is and/or were pointed to by the SP.

In an example, the cache line corresponds to an address range in the main memory, and the method further comprises: as the stack pointer updates, determining if stack pointer passes a predetermined threshold address; and if so, pre-fetching a further cache line of data from a main memory.

The method may further comprise: locking the at least one cache line including the pre-fetched data.

The method may further comprise: locking the address by overriding an output of a least recently used (LRU) logic to protect the cache line from eviction should a cache lookup result in a miss, a cache line eviction, and a cache line refill operation.

The method may further comprise: determining, by a lock detection circuit, whether a request address received from a processor corresponds with the locked address.

It should be noted that the methods and devices including its preferred embodiments as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiments outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

What is claimed is:

1. A cache system for a processor having a stack pointer register for storing a stack pointer, the stack pointer being an address in a main memory of a top of a stack, comprising:
a cache memory structured into cache lines; and
cache controller circuitry operable to:
receive the stack pointer,
store a first cache line containing contents of a first address range of bytes of the main memory, the first address range including the stack pointer; and
lock the first cache line to protect the first cache line from cache eviction.

2. The cache system of claim 1, wherein the cache controller circuitry is further operable,
when the stack pointer register contains a new stack pointer having an address outside the first address range, to:
store in the cache memory a further cache line containing contents of a further address range including the new stack pointer; and
lock the further cache line.

3. The cache system of claim 2, wherein the cache system locks the first cache line and the further cache line but unlocks any previous cache line corresponding to a previous stack pointer address.

4. The cache system of claim 1, wherein the cache controller circuitry is further operable to:
lock a plurality of addresses of respective cache lines that correspond to the stack pointer.

5. The cache system of claim 1, wherein the cache controller circuitry is further operable to:
determine a low threshold address in the first address range;
determine a high threshold address in the first address range;
determine that the stack pointer exceeds the high threshold address, and pre-fetch a further cache line of data from the address range in the main memory immediately above the first address range into the cache memory based on the determination that the stack pointer exceeds the high threshold address; or
determine that the stack pointer is below the low threshold address, and pre-fetch a further cache line of data from the address range in the main memory immediately below the low threshold address based on the determination that the stack pointer is below the low threshold address.

6. The cache system of claim 5, wherein the cache controller circuitry is further operable to:
lock the address of the further cache line including the pre-fetched data.

7. The cache system of claim 5, wherein the low threshold address and the high threshold address are each at a programmable position within the first cache line.

8. The cache system of claim 1, wherein the cache controller circuitry is operable to:
lock the address by overriding an output of a least recently used (LRU) logic to protect the first cache line from eviction when a cache lookup results in a miss, a cache line eviction, or a cache line refill.

9. The cache system of claim 8, wherein the cache controller circuitry comprises:
a lock detection circuit operable to determine whether a request address received from the processor corresponds with the locked address.

10. The cache system of claim 1, wherein the cache memory is organized as a multi-way set associative memory.

11. A microcontroller, comprising:
the cache system of claim 1.

12. The microcontroller of claim 11, further comprising:
the processor; and
the main memory,
wherein the cache system is communicatively coupled between the processor and the main memory to manage data flow therebetween.

13. A method for managing a cache memory structured into cache lines, comprising:
receiving, by cache controller circuitry from a processor, a stack pointer which indicates an address in a main memory of a top of a stack; and
locking, by the cache controller circuitry, a cache line including the top of the stack to protect the cache line from cache eviction.

14. The method of claim 13, further comprising:
updating the stack pointer to an updated address not stored in the cache line in the cache memory,
storing a further cache line corresponding to the updated address; and
locking the further cache line.

15. The method of claim 13, further comprising:
locking a plurality of cache lines that is and/or were pointed to by the stack pointer.

16. The method of claim 13, wherein the cache line corresponds to an address range in the main memory, the method further comprising:
as the stack pointer updates, determining that the stack pointer passes a predetermined threshold address; and
based on the determination that the stack pointer passes a predetermined threshold address, pre-fetching a further cache line of data from the main memory.

17. The method of claim 16, further comprising:
locking the further cache line including the pre-fetched data.

18. The method of claim 13, further comprising:
locking the address by overriding an output of a least recently used (LRU) logic to protect the cache line from eviction when a cache lookup results in a miss, a cache line eviction, or a cache line refill operation.

19. The method of claim 13, further comprising:
determining, by a lock detection circuit, that a request address received from a processor corresponds with a locked address corresponding to the cache line.

20. A computer system, comprising:
a processor including an address bus having M address lines;
a cache coupled to the address bus, the cache comprising a cache random access memory (RAM), and a cache controller circuit coupled to the cache RAM, the cache controller circuit comprising:
O index address lines coupled to O lines of the M address lines, wherein O<M;
N tag address lines coupled to N lines of the M address lines, wherein the N tag address lines are different from the O index address lines and N+O<=M;
K locking address lines, wherein K>=N+O;
O locking index lines coupled to O lines of the K locking address lines, wherein O<K;
N locking tag lines coupled to N lines of the K locking address lines, wherein the N locking tab lines are different from the locking index lines and N<K;
a locking index comparator having a first input, a second input, and an output; the first input of the locking index comparator coupled to the O index address lines and the second input of the first index comparator coupled to the O locking index lines;
a locking tag comparator having a first input, a second input, and an output; the first input of the locking tag comparator coupled to the N tag address lines and the second input of the locking tag comparator coupled to the N locking tag lines; and
a logic circuit having a first input and a second input, the first input of the logic circuit coupled to the output of the locking index comparator, and the second input of the logic circuit coupled to the output of the locking tag comparator.
